(19) United States
(12) Patent Application Publication
(10) Pub. No.: US 2013/0179789 A1
(43) Pub. Date: Jul. 11, 2013

(54) AUTOMATIC GENERATION OF A PRESENTATION

(71) Applicant: INTERNATIONAL BUSINESS MACHINES CORPORATION, Armonk, NY (US)

(72) Inventors: Bernd Beyrodt, Stuttgart (DE); Volker Hoose, Sindelfingen (DE)

(73) Assignee: INTERNATIONAL BUSINESS MACHINES CORPORATION, Armonk, NY (US)

(21) Appl. No.: 13/733,533

(22) Filed: Jan. 3, 2013

(30) Foreign Application Priority Data
Jan. 11, 2012 (EP) 12150708.1

(51) Int. Cl. G06F 3/01

(52) U.S. Cl. CPC G06F 3/01
USPC 715/730

(57) ABSTRACT

In one aspect, a method for assigning dynamic metadata to presentation pages is provided. The method includes storing presentation pages in a storage system, assigning static metadata to each presentation page of the presentation pages, and assigning the dynamic metadata to the presentation pages. Additionally, a method for selecting presentation pages is provided. In one aspect, this method includes receiving a selection parameter indicative of criteria for selecting presentation pages stored in a storage system, and selecting a group of presentation pages from the storage system based on static metadata, dynamic metadata, and the selection parameter.

### PRIOR FOREIGN APPLICATION

This application claims priority from European patent application number filed Jan. 11, 2012, which is hereby incorporated herein by reference in its entirety.

### BACKGROUND

Aspects of the invention relate generally to a method for assigning dynamic metadata to presentation pages, a method for selecting presentation pages, an assigning module for assigning dynamic metadata to presentation pages, as well as a selection module for selecting presentation pages. Aspects of the invention relate further to a computer system, a data processing program, and a computer program product.

In today's business life, computer-based presentations are most commonly used to (A) present information or (B) promote decision processes of different kinds Examples are: proposing new ideas based on innovation, laying out concepts to turn innovation into products, preparing decisions about various alternatives, informing customers and/or other stake holders about new products or functions, presenting research information, and so on.

Very often a lot of material is prepared in the form of computer-based presentations using presentation graphics software like, e.g., IBM Lotus Symphony, Microsoft PowerPoint, Open Office.org Impress and a lot of other proprietary or freely available presentation graphics software.

In both scenarios (A) and (B), it starts with an initial set of presentation slides which may be refined as time moves on. Slides are being created or added and varying selections may be used for presentation. For case (A), reuse tends to be bigger and the same set of slides may be used more than once. The lifetime of these presentations may be related to the currency of the information. For case (B), only fewer presentation slides may be reusable and reuse may be limited to project duration. Besides these quantitative differences, the problem is similar.

Through the various stages of a decision process, presentation material that has been created in prior stages may be used in later stages for efficiency reasons. In this case, an active selection has to take place, which material may be reused as a basis for the next project stage. This selection may typically be done by the presenter of the presentation.

In addition, presentations may often be held to various stake holders during a specific stage of a decision process. The presentation material, in particular, individual presentation pages, may then be reworked to fit the needs of a new audience. Again, an active selection may have to take place to identify the messages that are likely to be of interest for this specific new audience.

In case of informational presentations, the audience may change and with it the specific needs and expectations towards the content. An active selection and compilation of slides may be needed to do a successful presentation. However, in typical project situations, the preparation and selection of appropriate presentation pages may be a manual process.

Some approaches have been made in order to try to semi-automate or automate a generation of a presentation. Document U.S. Pat. No. 7,246,316 B2, incorporated hereby reference in its entirety, discloses systems and methods for generating slide presentations and enabling a user to generate presentations tailored to a specific target. An exemplary method includes: collecting information relating to a number of presentation targets, creating a number of presentation definition templates, each presentation definition template may include a number of slide descriptions, certain slide description sheets may include information place holders; and generating a slide presentation for the particular presentation target in accordance with the slide description of a specific presentation definition template.

In another document—US 2010/0122220 A1, incorporated hereby reference in its entirety—a method for dynamically generating a user presentation has been disclosed. The method includes selecting and retrieving at least one of a plurality of rules stored in one or more databases in response to a request from an application program, executing the rule to retrieve data from the one or more databases, and generating presentation data based on the data. The presentation data may be for use in a user presentation or an application program.

However, all known approaches are based on static information or they are template based.

### BRIEF SUMMARY

Therefore, there may be a need for an improved method for selecting presentation pages, in particular, a method that may allow a more dynamic way of selecting presentation pages. This need may be addressed by a method for assigning dynamic metadata to presentation pages, a method for selecting presentation pages, an assigning module, a selection module, a computer system, a data processing program, and a computer program product according to the independent claims.

In one embodiment, a method for assigning dynamic metadata to presentation pages may be provided. The method may comprise storing presentation pages in a storage system and assigning static metadata to each presentation page of the presentation pages. Additionally, the method may comprise assigning the dynamic metadata, which may comprise at least an average presentation time and a weighted importance, to every presentation page during and/or after an actual presentation, such that presentation pages may be selectable using a selection parameter indicative of criteria for selecting presentation pages stored in the storage system. The dynamic metadata may have been determined before the assigning.

In another embodiment, a method for selecting presentation pages may be provided. The method may comprise receiving a selection parameter (or multiple selection parameters) indicative of criteria for selecting presentation pages stored in the storage system, wherein each presentation page may have assigned static metadata and dynamic metadata, and wherein the dynamic metadata may comprise at least an average presentation time and a weighted importance.

Furthermore, the method for selecting may comprise selecting a group of presentation pages (or just a single one) from the storage system based on the static metadata and the dynamic metadata and the selection parameter such that additional presentation pages may be added to the group of presentation pages as long as a defined total presentation time is larger than a sum of the average presentation times of already selected presentation pages for the group of presentation pages, and such that presentation pages may be selected according to a decreasing weighted importance, wherein the weighted importance may have been determined during the actual presentation. In particular, they may also have been stored together with the presentation pages.

In another embodiment, an assigning module for assigning dynamic metadata to presentation pages may be provided. The module may comprise a storage system for storing presentation pages, and an assigning unit adapted for assigning static metadata to each presentation page of the presentation pages. The module may further comprise an assigning unit adapted for assigning (and, e.g., for determining of) dynamic metadata comprising at least an average presentation time and a weighted importance during and/or after (e.g., just after an actual presentation), such that presentation pages may be selectable using a selection parameter receivable from an input unit, the selection parameter being indicative of criteria for selecting presentation pages stored in the storage system.

In a further embodiment, a selection module for selecting presentation pages may be provided. The selection module may comprise an input unit adapted for receiving a selection parameter indicative of criteria for selecting presentation pages stored in a storage system, wherein each presentation page may have assigned static metadata and dynamic metadata. The dynamic metadata may comprise at least an average presentation time and a weighted importance. Additionally, a selection system may comprise a selection unit adapted for selecting a group of presentation pages from the storage system based on the static and the dynamic metadata and the selection parameter such that additional presentation pages may be added to the group as presentation pages as long as a predefined total presentation time may be longer than a sum of the average presentation times of already selected presentation pages for the group of presentation pages, and such that presentation pages may be selected according to a decreasing weighted importance.

### BRIEF DESCRIPTION OF THE SEVERAL VIEWS OF THE DRAWINGS

Embodiments of the invention will now be described, by way of example only and with reference to the following drawings:

FIG. 1a shows a block diagram of an embodiment of a method for assigning dynamic metadata, in accordance with one or more aspects of the present invention;

FIG. 1b shows a block diagram of an embodiment of a method for selecting presentation pages, in accordance with one or more aspects of the present invention;

FIG. 2 shows a block diagram of an embodiment of a method in more detail, in accordance with one or more aspects of the present invention;

FIG. 3a shows an embodiment of the assigning module, in accordance with one or more aspects of the present invention;

FIG. 3b shows an embodiment of the selection module, in accordance with one or more aspects of the present invention; and

FIG. 4 illustrates a computer system including aspects of the modules, in accordance with one or more aspects of the present invention.

### DETAILED DESCRIPTION

In the context of this application, the following conventions have been followed:

Presentation page—A presentation page may denote a page in a presentation given to an audience. The presentation may have been generated by a presentation graphics program like, e.g., Microsoft PowerPoint, Lotus Symphony, OpenOffice.org Impress, Apple Keynote, Google Docs, or others. A presentation page may be displayed using a beamer or may be viewed on a computer screen. Each presentation page may show content in textual, graphic or video form, and may—in some cases—be supported by sound effects. The related content may be animated or contain other visual effects. Typical animation effects from the graphics software may be used.

Presentation—The term presentation may denote either the process of giving a presentation to an audience or, may otherwise denote a group of presentation pages, or presentation slides, or simply slides. A group of presentation pages may be stored in a presentation file.

Storage system—A storage system may be any system in which presentation pages or other content may be stored. It may comprise a file system, a database of any form, a content management system or other storage concepts suitable to store presentation pages.

Static metadata—The term static metadata may denote specifications assigned to a presentation page like, e.g., a page ID, an originator, a project identifier, a target audience, a process stage of a page, an importance, a type and a time planned for presenting the specific page. All static metadata may be presentation page specific.

Dynamic metadata—The term dynamic metadata may also be presentation page specific. However, in contrast to the static metadata, the dynamic metadata are not static but dynamic, i.e., they may change over time without any human intervention. They may be based on measurements or derived otherwise from changing parameters. They may comprise a time span a specific presentation page may have been presented during a presentation. The dynamic metadata may also comprise a weighted importance and other metadata.

Average presentation time—The term average presentation time may denote a numerical value indicative of an average value a presentation page has been presented. It may be given in hours/minutes/seconds. It may be calculated based on all actual times of all presentations of a specific page divided by the number of presentations the page was used.

Weighted importance—The term weighted importance may denote a calculated value per presentation page. The weighted importance may denote a combined user-defined importance level and an actual importance that may be measured during a presentation. An example for a calculation method is given below.

It may also be noteworthy that the selection parameter may in fact be a plurality of selection parameters related to the static metadata and the dynamic metadata.

It may be noted that the presentation pages may represent pages with content, editable by a presentation graphics program, as mentioned above. Noteworthy may be as well that the selection may start with zero pages, meaning an empty presentation deck and that the group may comprise just one single presentation page depending on values of the selection parameters.

Furthermore, a skilled person will understand that the method for assigning dynamic metadata and the method for selecting presentation pages represent corresponding or inter-related elements of different aspects of assigning metadata to presentation pages as well as selecting the presentation pages at a later stage. The same applies to an inter-relationship between the assigning module and the selection module.

The above-described inter-related methods for assigning dynamic metadata and selecting presentation pages may offer a couple of advantages. Aspects of the method as well as the selection module may allow an automated, dynamic, self-learning way to select presentation pages for a new presentation. It may reflect the context of an organization, in which the presentation may be held, and the selection process may be performed without any human intervention apart from defining one or more selection parameters. The method and the selection module may capture dynamic metadata measured during previous and/or an actual presentation or dependencies between different presentation pages. In particular, a time may be measured during which a specific presentation page may be presented. After several times, in which the specified presentation page may have been used, average presentation time for a specific presentation page may be calculated. Thus, presentation material in the form of presentation pages may be selected automatically by a selection module based on a relevancy for a specific target audience.

In one embodiment, at least one element of the static metadata for the presentation page may be selected from the group consisting of a page identifier, an originator of the presentation page, a project identifier, a target audience of the presentation page, a predefined importance, in particular, a user-defined rating, a process stage of the page, a type of a page, a predefined presentation time, and a confidentiality flag.

The elements of the group may now be described. The page identifier may automatically be assigned to a presentation page and may—in one embodiment—use a composed key consisting of two parts: part one may be a file name of the presentation like “myPresentation.ext”. As part two, there may be a time stamp for the creation date and time of the specific presentation page noted in years/months/days/hours/minutes/seconds. So, an identifier may look like “myPresentation.ext2011090910317”.

Whenever an existing page may be copied into the new presentation, the identifier may also be copied over to the new presentation so that the original page may still be identifiable. When the copied page may be edited in the new presentation, a new identifier may be assigned to this newly generated page. The page identifier may be stored in the presentation file.

The “originator” may be a text string which may be manually assigned by entering a free text comprising a name and job function of the person that created the specific presentation page. The originator may be stored in the presentation file. When a page may be copied into a new presentation, the originator information may be copied as well. When a copied page may be modified in the new presentation, the originator information may be changed as well.

The field “target audience” and/or “project identifier” of the presentation page may be an array of text strings which may be manually assigned by either selecting predefined text, like developers, management, executives, marketing, customers, press, students, and so on. Or, it may be entered by a self-defined tag, like “customer ABC”. It may also be left empty by not selecting any tag. This may qualify the presentation page for any audience. The target audience may be stored in the presentation file.

The “predefined importance” may be entered by selecting from a predefined range of importance levels: 5—very high: in particular, for key messages, a presentation page that may always be selected for a specific content. 4—high: the presentation page may be important for preparing key messages or may be important for additional consideration/conclusions; it may be kept in new presentations. 3—medium: such a presentation page may be helpful for a deeper understanding. It may be selected if time allows. 2—low: such a presentation page may deliver detailed information. It may be selected if there may be enough time available in the presentation. It may also be left out. 1—very low: such an importance level may be used for additional information for potential side discussions during the presentation. It may be selected if time allows, and it may be useful as backup material. The importance level may be stored in the presentation file. Other importance levels may be defined as required or desired.

The metadata “process stage” may be a text string which may be manually assigned by either selecting predefined text like “idea, concept, plan, implementation, delivery, service” or others, or, by entering a self-defined text, like availability, decision or checkpoint. The process stage may be stored in the presentation file.

The “type of a page” may be a text string, which may be manually assigned by either selecting a predefined tag like “agenda, problem statement, executive summary, status report”, or others, or, by entering a self-defined tag, like e.g., “resource allocation”. The type of the page may be stored in the presentation file.

The field “predefined presentation time” may denote a time which may be planned for a presentation of the specific presentation page. The field predefined presentation time may be a time field which may be entered manually in minutes and seconds. The time may be stored in the presentation file.

Furthermore, there may be a “confidentiality flag” as part of the static metadata, such that a specific presentation page may be marked “confidential”. Several stages of confidentiality may be assigned using different values or different confidentiality flags.

Instead of storing the metadata into the presentation file, the metadata may also be stored outside but still related to the presentation file, allowing relationships between a presentation page and related metadata.

There may be one embodiment, wherein at least one element of the dynamic metadata for the presentation page may be selected from the group consisting of an actual audience identifier, a total time measured, a page time measured, a presentation counter, a page skip counter, a next page identifier, and a date used.

This may imply that presentation graphics software, as mentioned above, may be extended in order to include a selection software module to recall metadata about every page or slide of the presentation during and after actual presentations of the presented material.

The “actual audience” identifier may be a text string, which the presenter may have to specify when a presentation mode of the presentation graphics software may be entered. There may be an automatic prompt for an input. It may either be selected from a list of predefined text or it may be entered as a self-defined tag. The text string may be stored in the presentation file.

The dynamic metadata “total time measured” may be measured or recorded by a timer, which may be implemented within a selection module or the presentation graphics software. It may measure the time span from starting the presentation mode to ending the presentation mode in hours, minutes, and seconds. The result may also be stored in the presentation file.

The dynamic metadata “page time measured” may also be recorded or measured using a timer. It may measure the actual time span spent on a page whenever a specific page is displayed in presentation mode as part of a presentation. The result may be stored in the presentation file.

The field “presentation counter” may denote a number of times the current page has been presented in total in respect to a particular audience. It may be implemented as a counter that may count how often the page may be entered in presentation mode. Thus, there may be different counters, in particular, one per audience. Also, this counter may be stored as part of the presentation file.

The field “page skip counter” may denote a number of times a specific presentation page may have been skipped during a presentation in respect to a particular audience. It may be implemented as a counter that counts how often a specific page has been skipped in presentation mode of the presentation graphics software. Also, this counter may be stored as part of the presentation file.

A “next page identifier” may also be part of the dynamic metadata. It may identify a next page within the presentation so that it may become easy to jump backward or forward in a presentation. The next page identifier may be stored in the presentation file.

Last but not least, a “date used field” may be part of the dynamic metadata. It may denote a date stamp when a specific slide may have been presented. This may allow a correlation of pages, e.g., when a specific page was used in e.g., 90% of cases, another page was used as well. The field “date used” may be recorded as a typical time stamp in the format year/month/day and it may be stored in the presentation file.

After running a presentation, the presentation graphics software may determine or calculate additional results or metadata based on the measurements taken. This may include an “average time” a page may have been presented. It may be calculated based on the total time a presentation page was presented divided by the number of times a presentation page was presented in total and per audience. Thus, there may actually be two average time types: one type for all presentations and another one for specific audiences. Hence, the second type may have several instances depending on the number of audiences.

Additionally, an “actual importance” of the page may be calculated based on a relation of total time used for presenting the current page and total time used for the complete presentation. It may be expressed in IMPORTANCE ACTUAL=(TIME_ACTUAL[x]/TIME_TOTAL[x]/0,2), which result may be a number between 0 (not important) and 5 (very important), wherein “x” may be an identifier of a presentation page, TIME_ACTUAL may be the presentation time span for a single presentation page, and TIME_TOTAL may be the total time for a presentation.

Furthermore, a “weighted importance” of an actual presentation page may be calculated and become part of the dynamic metadata. It may represent an actual importance of the page weighted by the user-defined importance level. It may be calculated as follows: IMPORTANCE_WEIGHTED=PREDEFINED_IMPORTANCE*IMPORTANCE_ACTUAL, which may result in a number between 0 (not important) and 25 (very important). The PREDEFINED_IMPORTANCE may be the static metadata “predefined importance”, as defined above. A scaling may additionally be required.

Furthermore, page correlation information may be determined. It may denote which page may be used with other ones. It may be computed in the following form:

```
for SLIDE = 1 to NUMBER_OF_SLIDES
              retrieve identifier of current SLIDE
              search for identifier of page that has NEXT_PAGE=
              <identifier of current
              page> and assign to USED_WITH_SLIDE
              if there is no result, USED_WITH_SLIDE =
              identifier of previous page]
```

A person skilled in the art will understand immediately the meaning of the statement. This may enable an automatic determination of dependencies between different presentation pages.

Moreover, a deviation between a planned time and an actual time per presentation page may be determined in order to identify critical topics or critical presentation pages. The deviation may be calculated by: TIME_RELATION=TIME_ACTUAL[x]/TIME_PLANNED[x], wherein x may be the number of the current page and TIME_PLANNED may be the value for the predefined presentation time, as defined above.

Also actual values for the actual importance, the weighted importance and the page correlation may be stored together with a presentation file and may be related to a simple presentation page like all other metadata.

In one embodiment of the method, the selection parameter may be selected from the group consisting of a storage system indicator indicative of a name and/or a location of presentation pages to select from an audience type for the group of presentation pages, a total predefined presentation time for the group of presentation pages, and a confidentiality flag, indicative of a confidentiality level of the group of one or more of the presentation slides.

Based on these parameters as well as the static metadata and the dynamic metadata, the presentation graphics software module, which may have been extended, or a selection thereof, may be able to select presentation pages for a new presentation based on existing presentation pages using the above-described selection algorithm. Using these parameters may deliver sufficient information in order to allow an automatic selection of presentation material for a new presentation.

A user may input data for one or more of the following indicators or parameters: source of the existing material, in particular, a specific storage system, or specific file names of one or more existing presentations. Furthermore, an audience type of the presentation that may be created may have to be specified. Additionally, the available presentation time for the presentation that is to be created may be specified. Furthermore, it may be marked whether confidential information may be presented.

The selection algorithm as part of the selection module may collect static and dynamic metadata from all pages of the specific input material. Based on the set of available pages, a new subset may be selected by evaluating the metadata. Possible implementations of selection algorithms may, e.g., include:

New presentation pages may be chosen in the order of their weighted importance and in accumulation of the average presentation time for specific presentation pages. The algorithm that may be implemented in the presentation graphics software or the selection module may stop selecting additional pages when the accumulated average presentation time may reach the presentation time available, which may have been specified as a selection parameter.

In one embodiment of the method, the assigning dynamic metadata may comprise determining the average presentation time per presentation page during or after a presentation. In particular, an actual presentation time per presentation page may be recorded or measured during a presentation, i.e., while a presenter explains a presentation page. A page change may be initiated by a button activated by the presenter such that the beginning of displaying a presentation page as well as the end may be measurable or recordable. An internal clock of a computer used to support the presentation may be used for this purpose. E.g., at the end of the presentation, an average presentation time may be calculated or determined based upon previously related presentation times.

In a specific embodiment of the method, the assigning dynamic metadata may comprise calculation of the weighted importance after the presentation. This, as well as the calculation method, has been discussed above already. This weighted importance may be the most dynamic metadata and may represent the adaptive part of the method. Here, a self-adapting or self-learning behavior of the selection module or the algorithm, on which the method may be based, may come to life.

Furthermore, a computer or computer system may comprise the assigning module and/or the selection module, as described above, and referring to the methods. The selection module and/or the assigning module may also be implemented as one or more components of the presentation graphics system.

It should be noted that embodiments may take the form of an entire hardware implementation, an entire software embodiment or, an embodiment containing both, hardware and software elements. In a predefined embodiment, the invention may be implemented in software, which may include, but may not be limited to firmware, resident software and microcode. In another embodiment, a data processing program for execution in a data processing system may be provided comprising a software code portion for performing the method, as described above, when the program may be run on a data processing system. The data processing system may be a computer or a computer system.

Furthermore, embodiments may take the form of a computer program product, accessible from a computer-usable or computer-readable medium providing program code for use, by or in connection with a computer or any instruction execution system. For the purpose of this description, a computer-usable or computer-readable medium may be any apparatus that may contain means for storing, communicating, propagating or transporting the program for use, by or in a connection with the instruction execution system, apparatus, or device.

The medium may be an electronic, magnetic, optical, electromagnetic, infrared or a semiconductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

It should also be noted that embodiments of the invention have been described with reference to different subject-matters. In particular, some embodiments have been described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, but to which the invention is not limited.

In the following, a detailed description of the figures will be given. All illustrations in the figures are schematic. Firstly, a block diagram of an embodiment of the method for assigning of dynamic metadata to presentation pages as well as a block diagram of the method for selecting presentation pages will be described. Afterwards, embodiments of the methods and embodiments of the assigning module and selection module will be described.

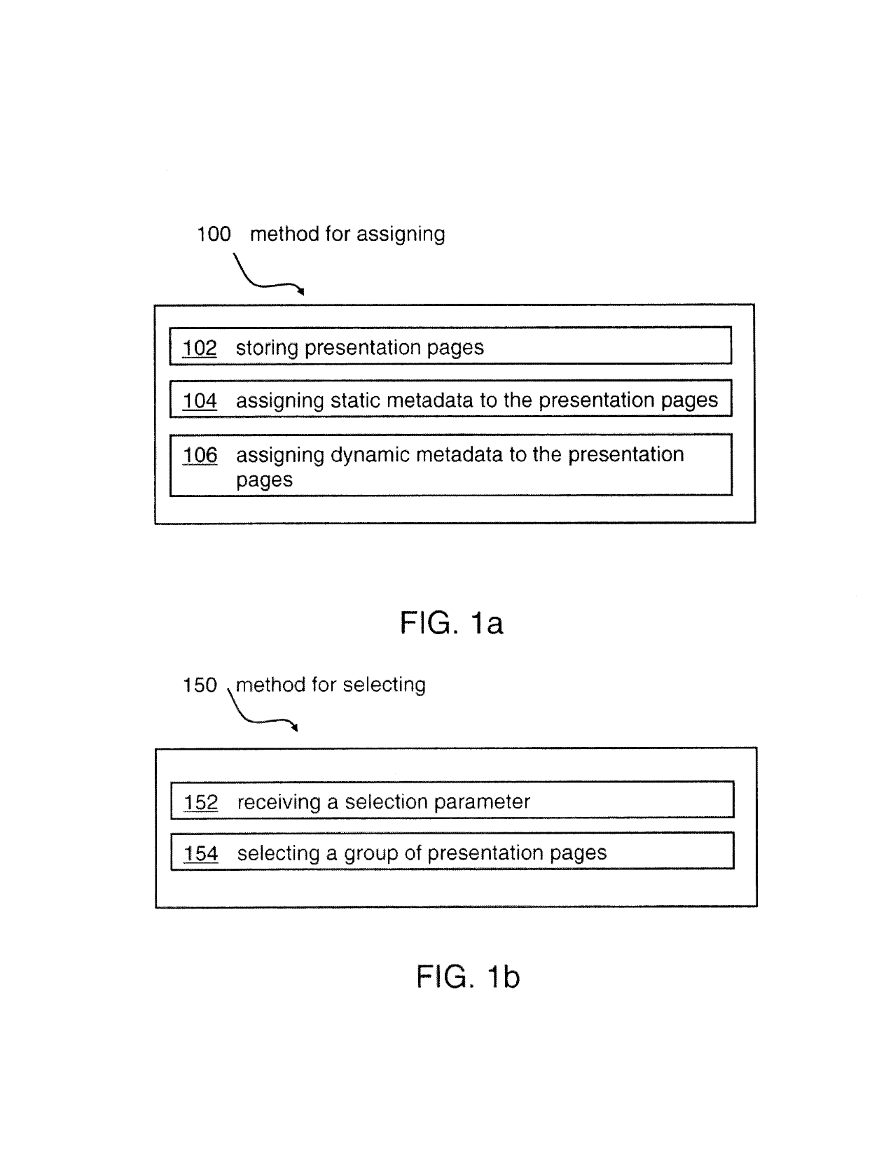

FIG. 1a shows a block diagram of an embodiment 100 of a method for assigning dynamic metadata, in accordance with one or more aspects. The method may comprise storing, 102, presentation pages in a storage system, assigning, 104, static metadata to each presentation page of the presentation pages, as well as assigning, 106, dynamic metadata comprising at least an average presentation time and a weighted importance to every presentation page during and/or after an actual presentation. This can be done, such that presentation pages may be selectable using a selection parameter indicative of criteria for selecting presentation pages stored in the storage system. In particular, all the metadata may be stored together with the related presentation page. The metadata may be used as a part of or all of the criteria. Hence the static and dynamic metadata are usable for selecting the associated presentation page for a presentation. More precisely the static and dynamic metadata are usable for deciding whether to select or deselect the associated presentation page for a presentation. This can be done under use of a selection parameter.

Once the metadata have been assigned in the above sense they may be used by an inter-related method for a selection of presentation pages.

FIG. 1b shows a block diagram of an embodiment of a method for selecting presentation pages, in accordance with one or more aspects of the present invention. The method may comprise receiving, 152, a selection parameter indicative of criteria for selecting presentation pages stored in a storage system. Each presentation page may have assigned static metadata and dynamic metadata. The dynamic metadata may comprise at least an average presentation time and a weighted importance. The method may further comprise selecting, 154, a group of presentation pages from the storage system based on the static metadata and the dynamic metadata, and the selection parameter, such that additional presentation pages may be added to the group of presentation pages as long as a predefined total presentation time may be larger than a sum of the average presentation times of already selected presentation pages for the group of presentation pages, and such that presentation pages may be selected according to a decreasing weighted importance.

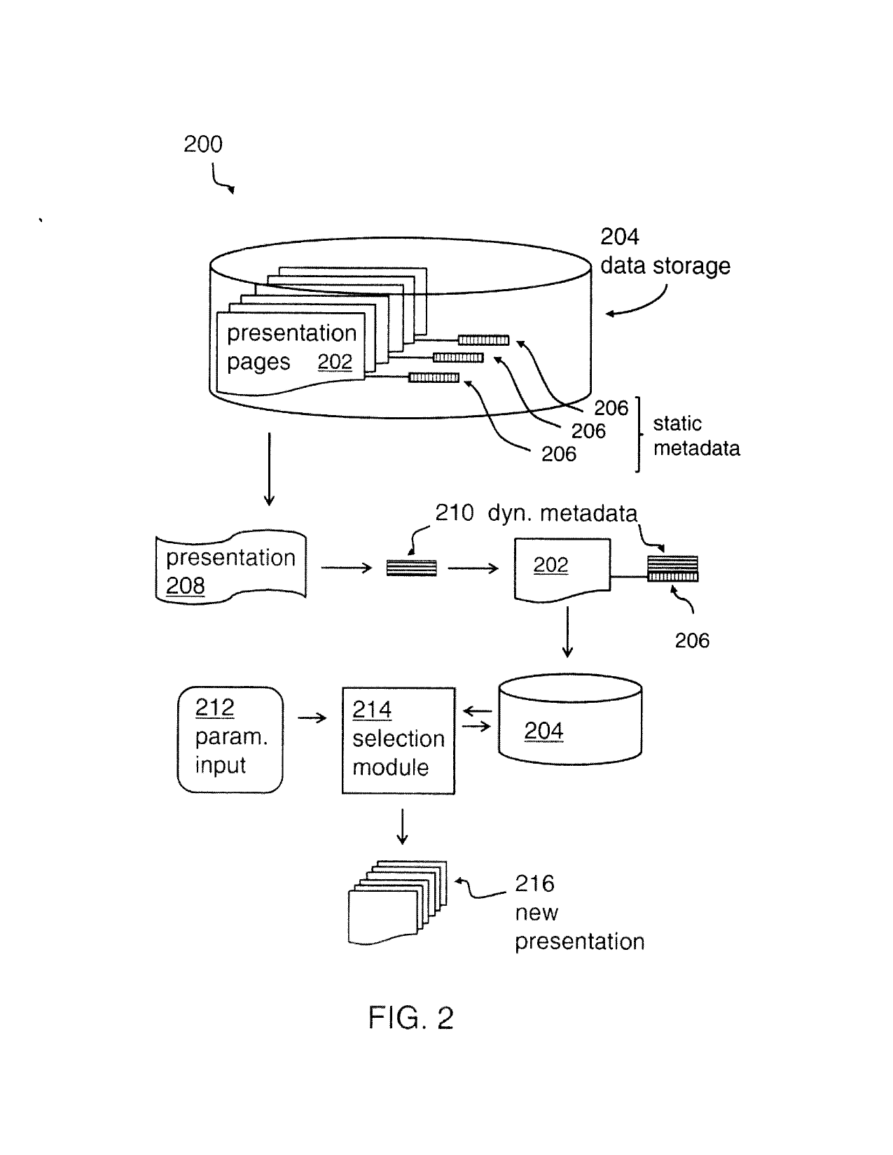

FIG. 2 shows a block diagram of an embodiment 200 of one or more aspects in more detail. Presentation pages 202 may have attached static metadata 206 and may be stored in a storage system 204. This may be a database adapted for storing semi-structured information, a content management system or a file system, or any other suitable storage system for storing presentation pages together with related metadata. A presentation 208, comprising a group of presentation pages 202, may be given by a presenter to an audience. During this process, dynamic metadata 210 may be collected and may be linked to the presentation pages in the same way this may have been done for the static metadata 206. Some metadata 206, 210 may be determined after the end of the presentation 208, other may be collected or measured during the presentation 208. One example may be an actual time spent for presenting a single presentation page 202. All dynamic metadata 210 may be individual for every presentation page 202. It may be noted that the reference numeral 206 may here be used for the static, the dynamic and the combined metadata. The presentation pages with the static 206 and dynamic 210 metadata may be stored in the storage system 204. A selection module 214 may receive input or selection parameters 212 and may select presentation pages 202 based on the metadata 206, 210 and the selection parameters (input parameters), and generate a new group of presentation pages 216.

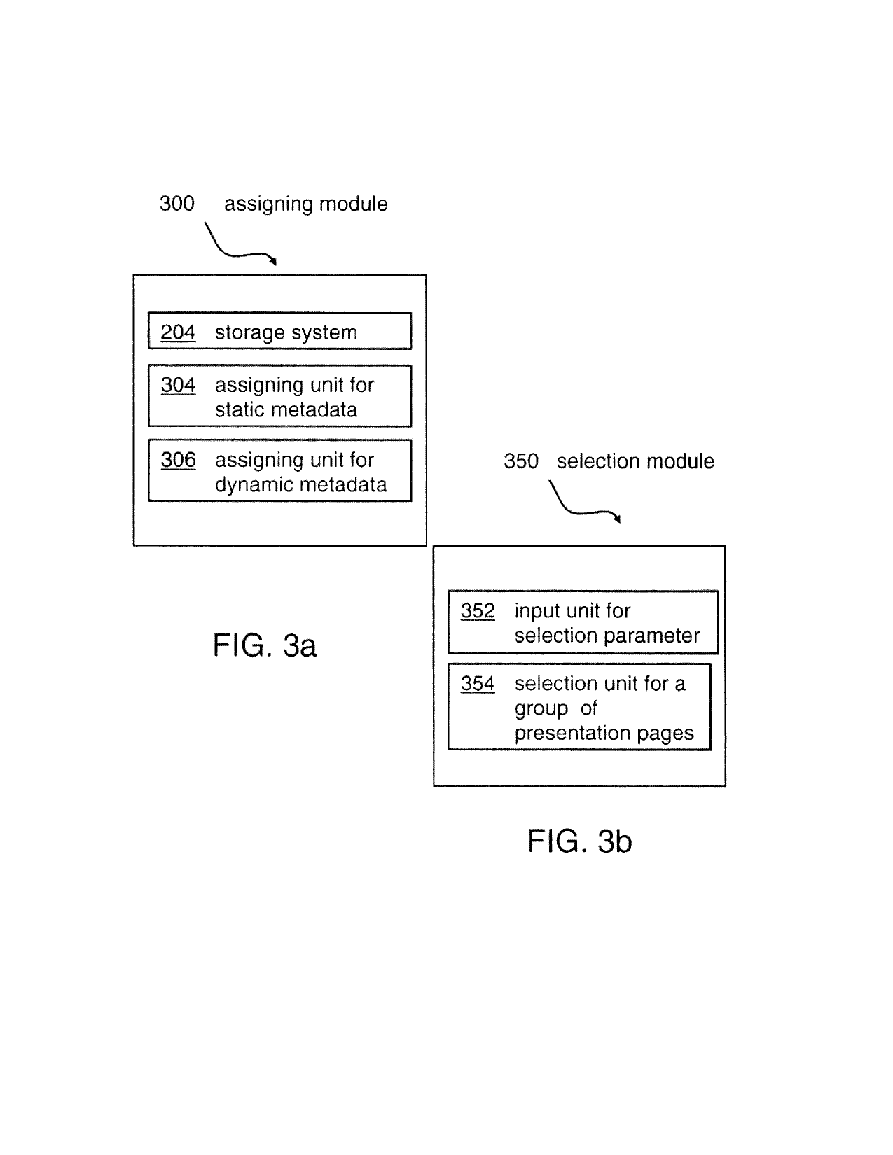

FIG. 3a shows an embodiment 300 of an assigning module. The assigning module 300 for assigning dynamic metadata to presentation pages may comprise a storage system 204 for storing the presentation pages, a first assigning unit 304 adapted for assigning static metadata to each presentation page of the presentation pages. The assigning module may further comprise a second assigning unit 306 adapted for assigning dynamic metadata comprising at least an average presentation time and a weighted importance to every presentation page during and/or after an actual presentation, such that presentation pages may be selectable using a selection parameter receivable from an input unit, the selection parameter being indicative of criteria for selecting presentation pages stored in the storage system 204. The right time for “after the presentation” may be determined based on a signal from a user signaling that an actual presentation has been finished. The static and dynamic metadata may be stored together with—but not necessarily within the same file—its related presentation pages.

FIG. 3b shows an embodiment 350 of the selection module. The selection module 350 for selecting presentation pages may comprise an input unit 352 adapted for receiving a selection parameter indicative of criteria for selecting presentation pages stored in a storage system. Each presentation page may have assigned static metadata and dynamic metadata. The dynamic metadata may comprise at least an average presentation time and a weighted importance. The selection module may further comprise a selection unit 354 adapted for selecting a group of presentation pages from the storage system based on the static metadata and the dynamic metadata and the selection parameter such that additional presentation pages (202) may be added to the group of presentation pages as long as a predefined total presentation time may be larger than a sum of the average presentation times of already selected presentation pages for the group of presentation pages, and such that presentation pages may be selected according to a decreasing weighted importance.

A skilled person will understand that the assigning module and the selection are inter-related components and are linked in an abstract way by the static and dynamic metadata that are used at different times by the modules.

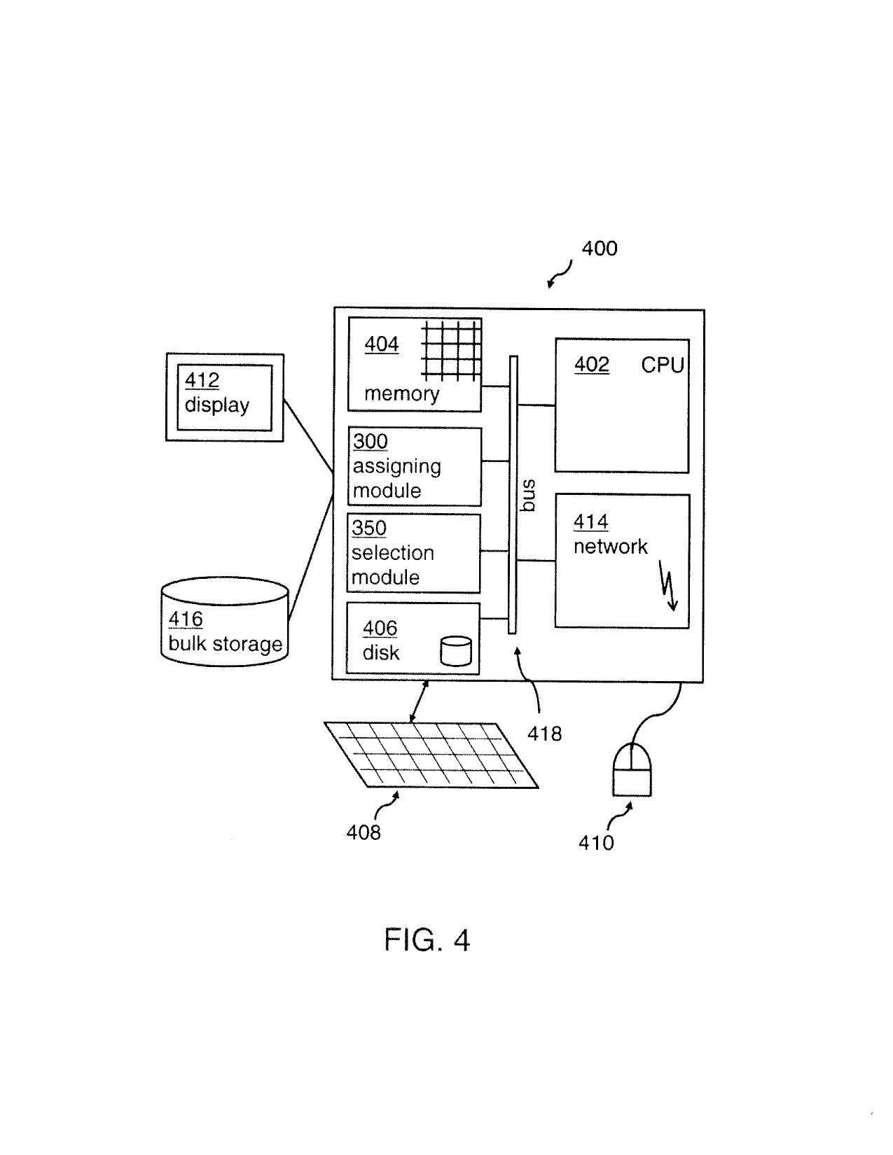

Embodiments of the invention may be implemented on virtually any type of computer, regardless of the platform herein used suitable for storing and/or executing program code. For example, as shown in FIG. 4, a computer system 400 may include one or more processor(s) 402 with one or more cores per processor, associated memory elements 404, an internal storage device 406, (e.g., a hard disk, an optical drive such as a compact disc drive or a digital video disc (DVD) drive, a flash memory stick, etc.), and numerous other elements and functionalities, typical of today's computer (not shown).

The memory elements 404 may include a main memory, e.g., a random access memory (RAM), employed during actual execution of the program code, and a cache memory, which may provide temporary storage of at least some program code and/or data in order to reduce the number of times code and/or data may be retrieved from a long-term storage medium or external bulk storage 416 for an execution. Elements inside the computer 400 may be linked together by means of a bus system 418 with corresponding adapter. Additionally, an assigning module 300 and/or a selection module 350 (compare FIGS. 3a and 3b) may be attached to the bus system 418.

The computer system 400 may also include input means, such as a keyboard 408, a pointing device such as a mouse 410, or a microphone (not shown). Furthermore, the computer 400, may include output means, such as a monitor or screen 412 [e.g., a liquid crystal display (LCD), a plasma display, a light emitting diode display (LED), or cathode ray tube (CRT) monitor]. The computer system 400 may be connected to a network (e.g., a local area network (LAN), a wide area network (WAN), such as the Internet or any other similar type of network, including wireless networks) via a network interface connection 414. This may allow a coupling to other computer systems, or a storage network or a tape drive. Those, skilled in the art will appreciate that many different types of computer systems do exist, and the aforementioned input and output means may take other forms. Generally speaking, the computer system 400 may include at least the minimal processing, input and/or output means, necessary to practice embodiments of the invention.

Further, those skilled in the art will appreciate that one or more elements of the aforementioned computer system 400 may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources or a smartphone.

Further, software instructions to perform embodiments of the invention may be stored on a computer readable medium, such as a compact disk (CD), a diskette, a tape, or any other computer readable storage device.

While the invention has been described with respect to a limited number of embodiments, those skilled in the art having benefit of this disclosure, will appreciate that other embodiments can be devised, which do not depart from the scope of aspects of the invention as disclosed herein. Accordingly, the scope of aspects of the invention should be limited only by the attached claims. It should also be noted that the term “comprising” does not exclude other elements or steps and “a” or “an” does not exclude a plurality. On the other side, the term “comprising” may also include the case of “consisting of”. Also, elements described in association with different embodiments may be combined. It should also be noted that reference signs in the claims should not be construed as limiting elements.

What is claimed is:

1. A method for assigning dynamic metadata to presentation pages, the method comprising:
storing presentation pages in a storage system;
assigning static metadata to each presentation page of the presentation pages; and
assigning the dynamic metadata comprising at least an average presentation time and a weighted importance to a presentation page, the assigning being performed at least one of during or after an actual presentation, wherein presentation pages are selectable using a selection parameter indicative of criteria for selecting presentation pages stored in the storage system.

2. The method according to claim 1, wherein at least one element of the static metadata for the presentation page is selected from the group consisting of a page identifier, an originator of the presentation page, a target audience of the presentation page, a predefined importance, a process stage of the page, a type of a page, a predefined presentation time, and a confidentiality flag.

3. The method according to claim 1, wherein at least one element of the dynamic metadata for the presentation page is selected from the group consisting of an actual audience identifier, total time measured, page time measured, presentation counter, a page skip counter, a next page identifier, a date used.

4. The method according to claim 1, wherein the assigning dynamic metadata comprises determining the average presentation time per presentation page after the presentation.

5. The method according to claim 1, wherein the assigning dynamic metadata comprises calculating of the weighted importance after the presentation.

6. A method for selecting presentation pages, the method comprising:
receiving a selection parameter indicative of criteria for selecting presentation pages stored in a storage system, wherein each presentation page has assigned static metadata and dynamic metadata, the dynamic metadata comprising at least an average presentation time and a weighted importance; and
selecting a group of presentation pages from the storage system based on the static metadata and the dynamic metadata, and the selection parameter, wherein additional presentation pages are added to the group of presentation pages as long as a predefined total presentation time is larger than a sum of the average presentation times of already selected presentation pages for the group of presentation pages, and wherein the presentation pages are selected according to a decreasing weighted importance.

7. The method according to claim 6, wherein the selection parameter is selected from the group consisting of a storage system indicator indicative of at least one of a name or a location of presentation pages to select from, an audience type for the group of presentation pages, a total predefined presentation time for the group of presentation pages, and a confidentiality flag indicative of a confidentiality level of the group of presentation slides.

8. A computer system comprising:
an assigning module for assigning dynamic metadata to presentation pages, said assigning module comprising:
a storage system to store the presentation pages;
a first assigning unit adapted to assign static metadata to each presentation page of the presentation pages;
a second assigning unit adapted to assign dynamic metadata comprising at least an average presentation time and a weighted importance to a presentation page at least one of during or after an actual presentation, wherein the presentation pages are selectable using a selection parameter receivable from an input unit, the selection parameter being indicative of criteria for selecting presentation pages stored in the storage system.

9. The computer system of claim 8, further comprising:
a selection module to select presentation pages, the selection module comprising:
a unit adapted to receive the selection parameter indicative of criteria for selecting presentation pages stored in the storage system; and
a selection unit adapted to select a group of presentation pages from the storage system based on the static metadata and the dynamic metadata and the selection parameter wherein additional presentation pages are added to the group of presentation pages as long as a predefined total presentation time is larger than a sum of the average presentation times of already selected presentation pages for the group of presentation pages, and such that presentation pages are selected according to a decreasing weighted importance.

10. A computer program product for assigning dynamic metadata to presentation pages, the computer program product comprising:
a computer readable storage medium readable by a processing circuit and storing instructions for execution by the processing circuit for performing a method comprising:
storing presentation pages in a storage system;
assigning static metadata to each presentation page of the presentation pages; and
assigning the dynamic metadata comprising at least an average presentation time and a weighted importance to a presentation page, the assigning being performed at least one of during or after an actual presentation, wherein presentation pages are selectable using a selection parameter indicative of criteria for selecting presentation pages stored in the storage system.

11. The computer program product according to claim 10, wherein at least one element of the static metadata for the presentation page is selected from the group consisting of a page identifier, an originator of the presentation page, a target audience of the presentation page, a predefined importance, a process stage of the page, a type of a page, a predefined presentation time, and a confidentiality flag.

12. The computer program product according to claim 10, wherein at least one element of the dynamic metadata for the presentation page is selected from the group consisting of an actual audience identifier, total time measured, page time measured, presentation counter, a page skip counter, a next page identifier, a date used.

13. The computer program product according to claim 10, wherein the assigning dynamic metadata comprises determining the average presentation time per presentation page after the presentation.

14. The computer program product according to claim 10, wherein the assigning dynamic metadata comprises calculating of the weighted importance after the presentation.
